(19) United States
(12) Patent Application Publication
(10) Pub. No.: US 2013/0290167 A1
(43) Pub. Date: Oct. 31, 2013

(54) SYSTEM AND METHOD FOR CREDIT RISK MANAGEMENT FOR EDUCATIONAL INSTITUTIONS

(71) Applicant: TRANS UNION LLC, (US)

(72) Inventors: Jason G. Laky, Highland Park, IL (US); Steven M. Chaouki, Chicago, IL (US); Sarah Kilburg, Oak Park, IL (US); Thomas J. Morrissey, Grayslake, IL (US); Edward G. Leong, Chicago, IL (US)

(73) Assignee: TRANS UNION LLC, Chicago, IL (US)

(21) Appl. No.: 13/866,836

(22) Filed: Apr. 19, 2013

Related U.S. Application Data
(60) Provisional application No. 61/636,482, filed on Apr. 20, 2012.

(51) Int. Cl. G06Q 40/02

(52) U.S. Cl. CPC G06Q 40/025
USPC 705/38

(57) ABSTRACT

A system and method for collecting, analyzing, assessing, and managing financial data of prospective, enrolled, and former students of an educational institution is provided. Student data and credit data corresponding to the students may be analyzed to create a compliance profile. Loan default likelihood factors may be determined based on the compliance profile. The students may be segmented into sub-populations based on the factors, the student data, and the credit data, and a risk baseline including risk criteria may be determined based on the segmentation. Prospective student leads may be screened for their repayment ability risk by utilizing the risk criteria to assist the educational institution in making financial aid and admissions decisions. A student loan portfolio may be assessed based on the risk criteria and credit data to identify at-risk accounts and to prioritize collections activities for past due accounts.

### RELATED APPLICATIONS

This application is a non-provisional application of U.S. Patent Application No. 61/636482, filed on Apr. 20, 2012, entitled “SYSTEM AND METHOD FOR CREDIT RISK MANAGEMENT FOR EDUCATIONAL INSTITUTIONS”, which is incorporated herein by reference in its entirety.

### TECHNICAL FIELD

This invention relates to a system and method for credit risk management and decision-making tools for educational institutions. More particularly, the invention provides a system and method for collecting, analyzing, assessing, and managing financial data of prospective, enrolled, and former students of an educational institution.

### BACKGROUND OF THE INVENTION

Post-secondary educational institutions, including for-profit and non-profit institutions, typically charge tuition and fees to students. Students often utilize financial aid in the form of student loans, scholarships, and grants to satisfy all or a portion of their tuition and fees. Funding for financial aid may originate from the government, the educational institution, and/or private sources, such as financial institutions. In the United States, educational institutions must comply with Title IV of the Higher Education Act in order to remain eligible to receive federal financial aid funds. In particular, one requirement that many educational institutions must satisfy is a 90/10 funding ratio requirement with regards to net revenue. The 90/10 funding ratio requirement specifies that particular educational institutions, such as for-profit educational institutions, can receive a maximum of 90% of their net revenue from certain federal financial aid funds in a given year. For purposes of the 90/10 funding ratio requirement, revenue is accounted for on a cash basis, i.e., as income is received, as opposed to an accrual basis, i.e., as income is earned. Accordingly, the amount and timing of incoming revenue to the educational institution, including repayments of student loans originating from the educational institution, may have a direct impact on compliance with the 90/10 funding ratio requirement and consequently, the educational institution's eligibility to receive federal financial aid funds.

Educational institutions may also have to comply with other requirements to remain eligible to receive federal financial aid funds, such as the cohort default rate and the gainful employment rule. The cohort default rate is a statistic showing how many federal student loan borrowers of the educational institution have entered repayment within the cohort fiscal year and defaulted on the loan (or met another specified condition) within a certain period, such as two or three years. Educational institutions with a cohort default rate at or above 25% over a two year period or 30% over a three year period may become ineligible to receive federal financial aid funds, e.g., loans and grants, for a sanction time period, such as three years. Educational institutions with a cohort default rate at or above 40% over a one-year period may become ineligible to receive portions of federal financial aid funds, e.g., loans, for a sanction time period, such as three years.

The gainful employment rule requires that former students of an educational institution be engaged in “gainful employment in a recognized occupation”, and is measured based on student debt levels and prospects for repaying student debt. Educational institutions must meet at least one of three metrics to satisfy the gainful employment rule: (1) a federal student loan repayment rate for former students of at least 35%; (2) a debt-to-income ratio for typical graduates of 12% or less; or (3) a debt-to-discretionary income ratio for typical graduates of 30% or less. An educational institution may lose federal financial aid funding eligibility if it does not meet one of these metrics three times over four consecutive fiscal years.

As a result, educational institutions may face challenges in meeting these regulatory requirements in order to remain eligible to receive federal financial aid funds. Educational institutions may need to rely more on out-of-pocket payments from students for tuition and fees as private student loans become less available, in order to comply with the 90/10 funding ratio requirement. Accordingly, identifying prospective and enrolled students with the capacity and willingness to pay out-of-pocket for tuition and fees becomes more important. In addition, enrolled and former students that have a higher proportion of educational debt from federal financial aid may have an increased likelihood of default. Optimally structuring the timing and amounts of tuition payment and financial aid may assist in complying with the 90/10 funding ratio requirement and other regulatory requirements. Educational institutions may also have limited or no contact with former students, which may result in a limited ability to directly influence the repayment of federal student loans by former students. It may also be difficult to obtain information regarding the pre- and post-education income of enrolled and former students. Without such income information, complying with the gainful employment rule may be more difficult.

Traditional student management solutions may determine a prospective student's likelihood to enroll at an educational institution, rather than the likelihood to repay a student loan. However, there may be a negative correlation between the likelihood of an individual to enroll and the likelihood of an individual to repay a student loan. For example, an individual with a relatively low credit score may have a higher likelihood to enroll but also a lower likelihood to repay a student loan. Similarly, an enrolled student with a relatively low credit score that is receiving a substantial amount of financial aid funds may be less likely to repay a student loan. Furthermore, due to government regulations, educational institutions may be forced to operate more like financial institutions and financial services companies. However, educational institutions do not always have sufficient financial data regarding prospective, enrolled, and former students to adequately satisfy the regulations.

Therefore, there is a need for a system and method that collects, analyzes, assesses, and manages financial data about prospective and enrolled students at an educational institution, in order to, among other things, ease compliance with financial aid regulations.

### SUMMARY OF THE INVENTION

The invention is intended to solve the above-noted problems by providing systems and methods for collecting, analyzing, assessing, and managing financial data about prospective and enrolled students at an educational institution. The systems and methods are designed to, among other things: (1) analyze student data and credit data to produce a compliance profile; (2) identify loan default likelihood factors based on the compliance profile; (3) segment a population of students into sub-populations based on the loan default likelihood factors, student data, and credit data; (4) determine a risk baseline including risk criteria, based on the sub-populations; (5) determine the repayment ability risk of prospective students by measuring credit data against the risk criteria; (6) periodically assess a student loan portfolio based on updated credit data and updated risk criteria; and (7) prioritize collections of past due student loans based on the likelihood of repayment.

In a particular embodiment, student data corresponding to a plurality of students at an educational institution may be received and credit data corresponding to the students may be retrieved. The student data and credit data may be analyzed to produce a compliance profile that correlates credit behaviors of the students with risk of loan default. Loan default likelihood factors may be identified based on the compliance profile. The students may be segmented into sub-populations based on the loan default likelihood factors, student data, and credit data. A risk baseline including risk criteria may be determined based on the sub-populations.

In another embodiment, a prospective student lead may be received from a lead decision controller and credit data corresponding to the prospective student lead may be retrieved. The repayment ability risk of the prospective student lead may be determined by measuring the student data against the risk criteria. The repayment ability risk may be transmitted to the lead decision controller.

In a further embodiment, a student loan portfolio may be assessed by determining one or more active and/or past due student loan accounts in the portfolio and retrieving updated credit data corresponding to the accounts. Risk trends of the active accounts may be identified based on the updated credit data. The updated credit data may also be used to identifying at-risk accounts of the active accounts. A repayment likelihood may be determined based on the credit data for the purposes of prioritizing collections activities of the past due accounts.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a block diagram illustrating a system for establishing a risk baseline of an educational institution based on student data and credit data, and for determining the repayment ability risk of prospective student leads based on the risk baseline.

FIG. 2 is a block diagram illustrating a system for assessing a student loan portfolio based on credit data and the risk baseline.

FIG. 3 is a block diagram of one form of a computer or server of FIGS. 1 and 2, having a memory element with a computer readable medium for implementing the systems described in FIGS. 1 and 2.

FIG. 4 is a flowchart illustrating operations for determining the risk baseline using the system of FIG. 1.

FIG. 5 is a flowchart illustrating operations for determining the repayment ability risk of prospective student leads using the system of FIG. 1.

FIG. 6 is a flowchart illustrating operations for assessing a student loan portfolio using the system of FIG. 2.

FIG. 7 is an illustrative graph showing segmentations of an exemplary student population with respect to risk and cumulative loan loss rates.

### DETAILED DESCRIPTION OF THE INVENTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

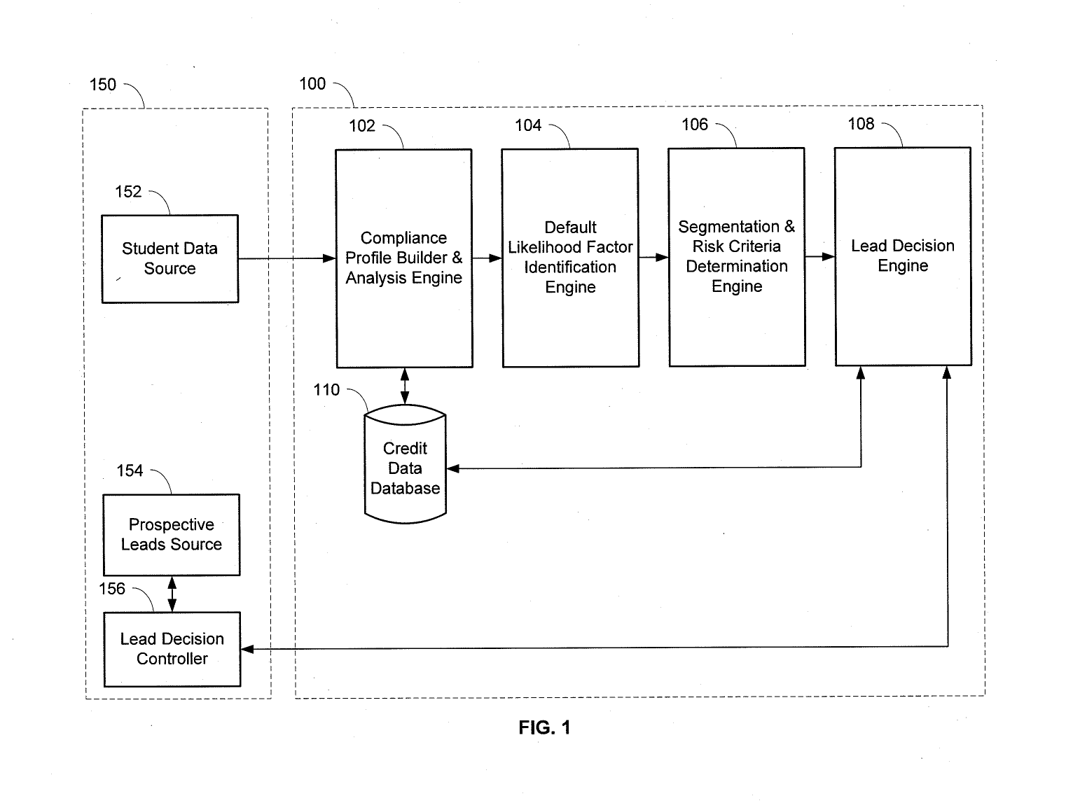

FIG. 1 illustrates a risk baseline determination and lead decision system 100 in accordance with one or more principles of the invention. The system 100 may utilize data received from a student data source 152 at an educational institution 150 and credit data from a credit data database 110 to determine a risk baseline of the educational institution 150. The determined risk baseline may include risk criteria, such as credit score cut-offs and knock-out rules, which are based on an analysis of the student data and the credit data. The system 100 may also utilize data received from a prospective student leads source 154 at the educational institution 150 and credit data from the credit data database 110 to determine a repayment ability risk of a prospective student. The determined repayment ability risk may assist in making financial aid and admissions decisions, as well as in pre-screening prospective students for marketing and pre-approval purposes. The repayment ability risk may include a score, a grade, a debt load characterization, and/or another metric, such as a decision to pass or not pass the prospective student lead for further admissions consideration and/or tagging the prospective student lead for different payment terms. The system 100 may be part of a larger system, such as a credit reporting system. The engines 102, 104, 106, and 108 in the system 100 may be implemented as one or more applications executing at a credit bureau, for example. By utilizing the system 100, the educational institution 150 can determine the credit behaviors that can forecast an individual's risk of defaulting on a student loan and assist the educational institution in complying with governmental regulations, such as those related to Title IV of the Higher Education Act (HEA) in the United States.

The governmental regulations include satisfying the 90/10 funding ratio requirement, meeting the cohort default rate, and meeting at least one of the metrics included in the gainful employment rule. The educational institution must comply with these regulations in order to remain eligible to receive federal financial aid funds. The 90/10 funding ratio requirement specifies that certain educational institutions, such as for-profit educational institutions, can receive a maximum of 90% of their net revenue from federal financial aid funding in a given year. Federal financial aid funding may include the Federal Pell Grant Program, the Federal Supplemental Educational Opportunity Grant (SEOG), the Federal Work-Study Program, the Stafford Loan Program, and the Federal Perkins Loan Program. In addition, scholarships funded by the educational institution may be counted towards the 90% portion of the 90/10 funding ratio requirement.

Accordingly, the educational institution must receive a minimum of 10% of their net revenue from sources other than federal financial aid funding. Direct cash payments from students, private loans, non-institutional loans, non-institutional scholarships, non-federal grants, private grants, military educational loans and benefits (e.g., G.I. Bill), and repayments of previously extended institutional loans (e.g., student loans originating from the educational institution) may be counted towards the 10% portion of the 90/10 funding ratio requirement. For example, if a student receives funds from a private loan and gives the funds to the educational institution for payment of tuition, those funds may be counted towards the 10% portion of the 90/10 funding ratio requirement. In this case, if the student subsequently does not repay the private loan and the private loan is a non-recourse loan, there is no effect on the educational institution with respect to the 90/10 funding ratio requirement. However, if the student subsequently does not repay the private loan and the private loan is a recourse loan and/or the educational institution has some contractual interest in the private loan, then the non-repayment of the private loan may have an effect on the educational institution with respect to the 90/10 funding ratio requirement.

Therefore, the revenue that may count towards the 10% portion of the 90/10 funding ratio requirement therefore includes only payments not associated with federal financial aid funds, e.g., revenue associated with Title IV of the HEA, which the school actually received in a given year. For purposes of the 90/10 funding ratio requirement, revenue is accounted for on a cash basis, i.e., as income is received. As such, whether a student will be able to pay tuition and fees out-of-pocket; qualify for private loans, grants, and scholarships; and/or repay their institutional loans in the future may have a direct impact on the 10% portion of the 90/10 funding ratio requirement.

The cohort default rate specifies that a maximum of 40% over one year, 25% over two years, or 30% over three years of former students of an educational institution can default on their federal student loans. If the cohort default rate is not met, the educational institution may become ineligible to receive some or all types of federal financial aid funds for a sanction time period. The gainful employment rule specifies that former students of an educational institution must be engaged in “gainful employment in a recognized occupation”, based on the former students' debt levels and prospects for repaying student debt. At least one of three metrics must be met to comply with the gainful employment rule: (1) a federal student loan repayment rate for former students of at least 35%; (2) a debt-to-income ratio for typical graduates of 12% or less; or (3) a debt-to-discretionary income ratio for typical graduates of 30% or less. With respect to the federal student loan repayment rate, the student loans being repaid by the former students must have a lower principal balance over the course of a year to be considered not in default. An educational institution may lose federal financial aid funding eligibility if it does not meet one of these metrics three times over four consecutive fiscal years. In summary, if some or all of the above-described government regulations are not complied with, the educational institution may become ineligible for some or all federal financial aid funds and therefore lose the bulk of their revenue.

It should be noted that the specific ratios, percentages, and requirements described above are based on present laws, rules, and regulations, and are subject to change according to rules promulgated from governmental agencies (e.g., the Department of Education) and/or legislation, such as periodic reauthorizations of the Higher Education Act by Congress. Although present laws, rules, and regulations primarily apply the above-described requirements to for-profit educational institutions, it is possible and contemplated that the same, similar, and/or related requirements may apply to non-profit educational institutions in the future. The system 100 may therefore assist any type of educational institution in easing compliance with such requirements by finding prospective and enrolled students who may have less of a need for federal financial aid funding, and who may be more likely to repay their student loans in the future.

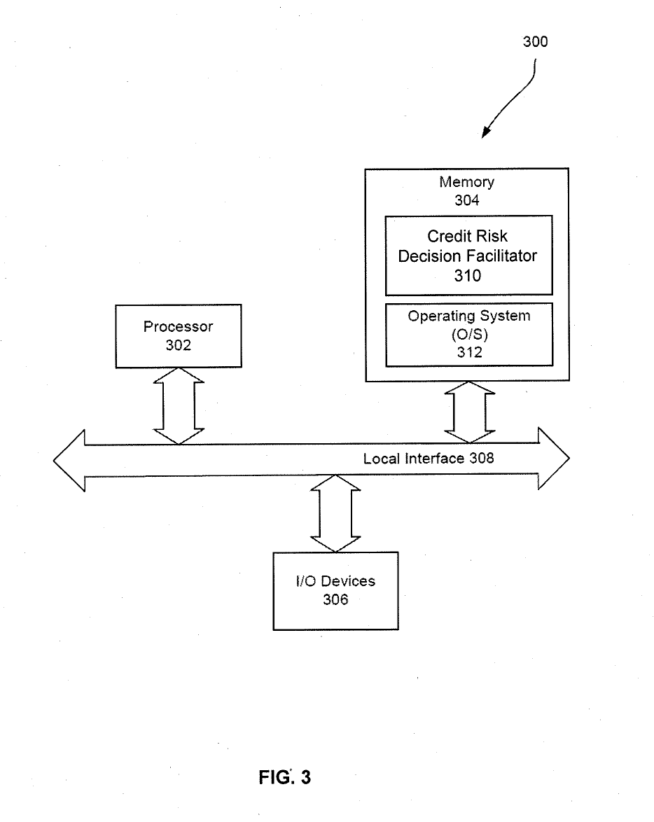

Components of the system 100 and at the educational institution 150 may be implemented using software executable by one or more servers or computers, such as a computing device 300 with a processor 302 and memory 304 as shown in FIG. 3, which is described in more detail below. In one embodiment, the system 100 can perform a retrospective analysis to determine a compliance profile of the educational institution 150, based on student data and credit data corresponding to students in the student data. In another embodiment, the system 100 can identify loan default likelihood factors, such as credit-based scores and attributes, which match desired risk and acquisition outcomes of the educational institution 150, based on the compliance profile. Such outcomes are described further below. In a further embodiment, the system 100 may segment the students in the student data into sub-populations based on the loan default likelihood factors, and determine a risk baseline that includes risk criteria, based on the segmentation. The risk criteria may be returned to the educational institution 150. The risk criteria may also be used to make financial aid and admissions decisions with respect to prospective student leads. In this embodiment, credit data related to a prospective student lead may be measured against the risk criteria to assist in the financial aid and admissions decisions.

In order to satisfy the above-described government regulations, findings related to credit data may be leveraged across the academic lifecycle of a student at an educational institution, including targeting of prospective students (e.g., origination programs), student loan underwriting, student account and loan management, post-graduation collections and fraud management, and retention and cross-sell functions. In particular, when targeting prospective students, individuals with acceptable default risks and individuals with higher default risks may be identified so that recruitment efforts are focused on the individuals with the acceptable default risks. When enrolling a student and underwriting a student loan, the capacity of an individual to service their debt, given their total debt and income, can be analyzed. While managing student accounts and loans, at-risk students who may withdraw because of a change in ability to pay may be identified. The educational institution may be able to assist these at-risk students by changing payment terms, for example. In addition, the collection activity of defaulted loans can be prioritized to focus on the loans that have a greater likelihood of repayment.

A compliance profile builder and analysis engine 102 may analyze student data and credit data to produce a compliance profile that correlates credit behaviors of students with loan default risk. Student data may be received at the engine 102 from a student data source 152 at the educational institution 150. The student data may include current and/or historical information for one or more enrolled and/or former students of the educational institution 150. In some embodiments, the student data for the enrolled and/or former students may include information for two, three, and/or four years preceding the current year. Student data from other time periods may also be utilized in other embodiments. The number of enrolled and/or former students included in the student data may vary based on the size of the educational institution, the analysis needs of the educational institution, and other considerations. Student data for a statistically valid sample of enrolled and/or former students may be sufficient to produce the compliance profile. A statistically valid sample may include information for some or all of the enrolled and/or former students.

Information in the student data may include all or some of the following: full names, former names, current and previous addresses, social security numbers, other identification numbers, enrollment dates, dates of birth, areas of study, types of access to the institution (e.g., online or on campus), program phases, graduation/separation dates, grades, grade point averages, payment history (including payments made exclusively by the student), employment status, and financial aid package details (e.g., amounts and terms of grants, loans, etc.). An increased frequency, depth, and/or duration of the student data can be beneficial so that the engine 102 can analyze and build a compliance profile with more detail and accuracy. Enrolled and former students may have provided some or all of the student data in the student data source 152 to the educational institution 150 at the time of application, during enrollment, after graduation/separation, and/or in a financial aid application, for example. Some or all of the student data in the student data source 152 may have been derived by the educational institution 150 during the course of the students' enrollment.

The information in the student data may be selected based on the analysis needs and desired outcomes of the educational institution. For example, if the educational institution is concerned about satisfying the 90/10 funding ratio requirement, the information in the student data may focus on recently enrolled students and/or early dropouts, withdrawals, or dismissal rates on a per program basis. Analyzing this relatively newer data may give insight on why the educational institution may be having issues satisfying the 90/10 funding ratio requirement, since this requirement accounts for revenue on a cash basis, i.e., as income is received by the educational institution. As another example, if the educational institution is concerned about satisfying the cohort default rate or the gainful employment rule, the information in the student data may be focused on graduated students and students who did not complete their programs. In this case, analyzing this relatively older data may assist in determining why the educational institution may be having issues satisfying the cohort default rate or the gainful employment rule, since these rules focus on the repayment and income statistics of graduated students and former students.

Credit data corresponding to each enrolled and former student in the student data may be retrieved from a credit data database 110 by the engine 102. Credit data may include a record of an individual's credit history, such as credit records and loan amounts for credit cards, mortgages, automobile loans, student loans, etc., as well as any payment delinquencies and charge-off history. Many industries, such as financial services, insurance, and telecommunications, utilize credit data in making financial-related decisions with respect to consumers. Measurement and management of risk may be based on credit data through the use of credit scores and critical credit-based attributes. Credit scores may be generic or customized, and may aggregate credit data into a single risk assessment, e.g., the likelihood of a charge-off in a given period of time. Credit scores may include products such as VantageScore and FICO. Examples of critical credit-based attributes include credit score, default history, delinquency history, available credit, credit sought, credit used, high balances in relation to credit limits, multiple credit inquiries, and/or recent credit inquiries. Critical credit-based attributes may also include information derived from the educational institution, such as name, address, degree program, prior education, and/or other information. Through the analysis of the credit data of enrolled and former students with the system 100, the credit data of prospective and enrolled students may be utilized as a significant predictor of an individual's likelihood to repay a student loan, and in particular, provide insight into the individual's ability and willingness to repay the student loan, as described further below.

The engine 102 may retrospectively analyze the student data and the credit data to produce a compliance profile for the educational institution 150 that correlates credit-related behaviors of students with loan default risk. This retrospective analysis may weight, compare, and contrast particular factors and parameters of the student data and the credit data in order to produce the compliance profile. One or more formulas may take into account some or all of the student data and/or some or all of the credit data in determining the compliance profile. The compliance profile may include a comprehensive overview of the characteristics of enrolled and former students who have defaulted on student loans or been delinquent in repayment. In particular, the compliance profile may include a series of decisioning rules and performance expectations that are based on credit score bands and/or segmentation of the compliance profile that are related to certain outcomes. For example, the compliance profile may include credit score bands and/or profile segmentations corresponding to the likelihood for a student to withdraw or be dismissed within the first 90-180 days of their initial enrollment, the likelihood for a student to default on cash payment terms within 90 days or their first academic term, the likelihood for a student to be delinquent on their student loan after separation from the educational institution or within the first year of repayment of the student loan, and/or other outcomes. Underwriting of future student loans may be based on the compliance profile, as described further below.

Factors that best predict the likelihood of default may be derived from the compliance profile by the default likelihood factor identification engine 104. The factors may include credit-based scores and attributes in an individual's credit data and credit history. The scores and attributes may be customized to match the desired risk and student acquisition outcomes as identified by the educational institution 150. Outcomes may include, for example, whether or not to extend a loan offer (e.g., requiring tuition to be paid in full), offering a custom payment plan based on particular aspects of the credit data, and offering an institutional loan. Scores and attributes derived by the engine 104 may include credit score ranges and thresholds, particular characteristics of students, and the like. Other metrics may be identified by the engine 104, such as qualification of students for the Federal Pell Grant Program, the financial capacity of a prospective student to pay the entire tuition cost, and different mixes of financial aid package components. For example, a credit score range-based metric may include that students with a credit score, e.g., VantageScore, of 501 have a 90-day withdrawal rate of 55%, a graduation rate of less than 4%, and a cohort default rate of 75%. The metric may also include that students with a credit score, e.g., VantageScore, of 770 or greater have an academic persistency rate (e.g., staying enrolled for at least 13 months) of 80%, a graduation rate of 60%, and a cohort default rate of less than 15%.

The enrolled and former students in the student data may be segmented into sub-populations by the segmentation and risk criteria determination engine 106, based on the default likelihood factors derived by the engine 104. For example, it may be determined that a particular higher risk portion of the enrolled and former students is responsible for a larger percentage of losses due to loan defaults. By identifying these higher risk sub-populations, future loan repayment risk to the educational institution 150 may be mitigated. Based on the segmentation of the student data into sub-populations, the engine 106 may also determine a risk baseline that includes risk criteria, such as credit score cut-offs and knock-out rules. The risk criteria may be determined by analyzing the sub-populations and the student data and credit data associated with each of the sub-populations. In particular, credit score cut-offs may include thresholds and/or credit score intervals that place individuals into the same sub-population for purposes of determining their default risk. Knock-out rules include particular criteria that can approve or reject an individual for a loan, keep a prospective student from being contacted for follow-up, etc. Examples of knock-out rules may include a negative credit event that affects approval of a loan; prospective students having a low credit score, e.g., a VantageScore of 501 or lower that will not be contacted for follow-up; students in certain adverse sub-populations in the compliance profile that will not be contacted, etc.

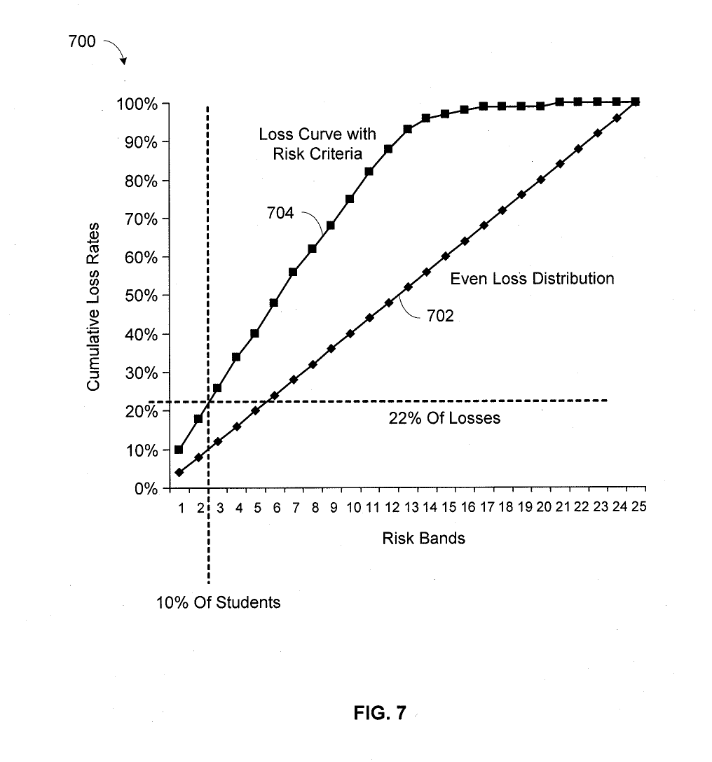

An illustrative graph 700 is shown in FIG. 7 that displays segmentations of an exemplary enrolled and former student population in bands of decreasing risk on the horizontal axis and cumulative loan loss rates on the vertical axis. The lower-numbered risk bands may roughly correspond to individuals with a lower credit score, for example. The curve 702 shows an even distribution of loan losses across the student population. For the curve 702, it is assumed that each segment of the student population equally contributes to the loan losses of the educational institution 150. The curve 704 shows the distribution of loan losses when risk criteria are taken into account. It can be seen by the curve 704 that a disproportionate level of loan losses may be caused by a relatively small portion of the student population. In the example of FIG. 7, 22% of loan losses are caused by 10% of the student population. The risk criteria determined by the system 100 for this sub-population of the student population can assist in identifying prospective and enrolled students that correspond to this sub-population and likely have a higher risk of loan default, and furthermore, impact the ability of the educational institution 150 to meet financial aid regulations, including the 90/10 funding ratio requirement.

A lead decision engine 108 may be used for automated or semi-automated underwriting of student loans and can be integrated into the admissions process for the educational institution 150. The lead decision engine 108 can utilize the risk criteria determined by the engine 106, described above, as well as prospective student leads and credit data corresponding to the prospective student leads to determine the repayment ability risk of prospective students. By using the risk criteria determined by the engine 106, prospective students can be screened to determine their likelihood to default on a student loan. A lead decision controller 156 at the educational institution 150 may have access to a prospective student leads sources 154. The prospective student leads source 154 may include information about prospective students, such as their name, social security number, other identification numbers, address, last educational institution attended, degrees attained, program(s) of interest, student information unique to particular educational institutions, and other information. Information about the prospective students in the prospective student leads source 154 may be provided by a third party and/or from existing students. A third party may include, for example, an online lead generator website that a prospective student has visited when looking for educational information. An existing student may be considered a prospective student lead if the existing student is trying to acquire initial or additional financing to continue their education.

All or some of the individuals from the prospective student leads source 154 may be passed to the lead decision engine 108 for a decision regarding student loan eligibility and admissions. Passing all of the prospective student leads to the engine 108, regardless of the source of the leads, will allow the educational institution 150 to have a consistent financial aid and admissions strategy across all acquisition channels. The engine 108 may also be used for marketing purposes, such as pre-screening of prospective students to provide pre-approved offers of student loans and other financial aid. Credit data for each of the prospective leads may be retrieved from the credit data database 110 by the engine 108. The credit data may also include an income estimate, a debt-to-income estimate, and/or other financial-related information for the prospective leads. The engine 108 can measure the credit scores and attributes in the credit reports of the prospective students against the risk criteria to determine a repayment ability risk of the prospective student lead, e.g., whether the prospective student lead meets the risk criteria.

The determined repayment ability risk of the prospective student lead may include a score, a grade, a debt load characterization, and/or another metric. For example, the metric for the repayment ability risk may include: (1) a pass, e.g., meeting the risk criteria; (2) no pass, e.g., not meeting the risk criteria; or (3) tag for different payment terms, e.g., meeting some of the risk criteria. Scores or grades may include, for example, a numeric, alphanumeric, and/or alphabetic rating of the repayment ability risk of the prospective student. The debt load characterization may include, for example, whether a prospective student will have a low need, high need, or maximum need for financial aid. The lead decision controller 156 may receive the determined repayment ability risk from the engine 108. Using credit data in deciding financial aid and admissions for prospective student leads assists in eliminating the cost of acquiring leads that do not qualify for the financial terms of the educational institution 150. Different strategies may be utilized by the educational institution 150 to encourage prospective student leads to enroll, such as by offering different payment plans, financial aid packages, etc.

For example, a prospective student lead may be determined to have a repayment ability risk of “no pass” based on having a credit score below a certain minimum score and/or a negative credit attribute, such as having an account in the last two years that is 60 or more days past due, or having a charged off mortgage. The repayment ability risk of a prospective student lead may also be dependent on the outcome sought by the educational institution. For example, if more than 90% of the students of an educational institution are receiving federal financial aid, the educational institution may have difficulty satisfying the 90/10 funding ratio requirement. In this case, students with high and low individual federal financial aid ratios can be identified using the lead decision controller 156. The educational institution can thus balance the number of students with high and low financial aid ratios so that the educational institution can enroll better quality students and meet or exceed the federal financial aid regulations and laws, e.g., the 90/10 funding ratio requirement, the cohort default rule, and/or the gainful employment rule.

Students with high individual 90/10 ratios, e.g., receivers of a relatively large amount of federal financial aid, but who graduate, repay their student loans, and obtain well-paying jobs may negatively affect the 90/10 funding ratio of the educational institution in the short term, but positively impact the cohort default rate and gainful employment rule of the educational institution in the long term. Students with low individual 90/10 ratios, e.g., receivers of a relatively small amount of federal financial aid, will positively affect the 90/10 funding ratio in the short term. If these particular students graduate, repay their student loans, and obtain well-paying jobs, they will also positively impact the cohort default rate and gainful employment rule of the educational institution in the long term.

The risk criteria may be updated at the segmentation and risk criteria determination engine 106 on a periodic basis, on a continual basis, and/or when there are changes to the credit data of students. Any updates or changes to the credit data corresponding to the students in the student data source 152 may subsequently be incorporated into further analysis and decisions made by the engines 102, 104, and 106, as described above. Similarly, subsequent updates to the risk criteria may be incorporated into further analysis and decisions made by the engine 108, as described above. Updates and changes to credit data may also be utilized by the portfolio review engine 202, described below, when analyzing, assessing, and managing student accounts and loans that have an active relationship with the educational institution 150.

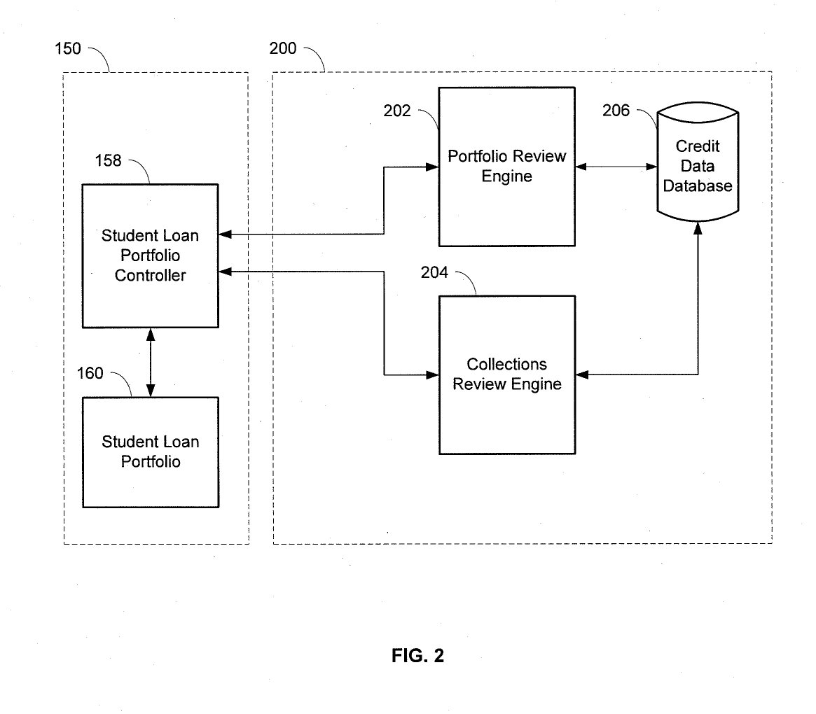

FIG. 2 illustrates a student loan portfolio assessment system 200 in accordance with one or more principles of the invention. The system 200 may utilize student loan portfolio data received from a student loan portfolio controller 158 at the educational institution 150 to assess and manage existing student loans. The system 200 may be part of a larger system, such as a credit reporting system. The engines 202 and 204 in the system 200 may be implemented as one or more applications executing at a credit bureau, for example. By utilizing the system 200, the educational institution 150 can manage revenue and loan defaults within their existing student loan portfolio. The system 200 can be integrated with the system 100 described above. For example, credit data previously retrieved by the engines 102 or 108 may be accessible to the engines 202 or 204.

Components of the system 200 and at the educational institution 150 may be implemented using software executable by one or more servers or computers, such as a computing device 300 with a processor 302 and memory 304 as shown in FIG. 3, which is described in more detail below. In one embodiment, the system 200 can identify active at-risk accounts in a student loan portfolio based on credit data and risk trends. In another embodiment, the system 200 can prioritize the collections of past due accounts based on a likelihood of repayment.

A portfolio review engine 202 may conduct credit-based reviews of a student loan portfolio 160 as requested by a student loan portfolio controller 158 at the educational institution 150. The student loan portfolio 160 may include account information for existing federal and institutional student loans extended to enrolled and former students of the educational institution 150. Such account information may include names, social security numbers, other identification numbers, amounts and dates of the student loans, repayment history of the student loans, and/or other information. The enrolled and former students may have provided some or all of the account information in the student loan portfolio 160. Some or all of the account information in the student loan portfolio 160 may have been derived by the educational institution 150 during the course of the students' enrollment.

The student loan portfolio controller 158 and/or the portfolio review engine 202 may determine which accounts in the student loan portfolio 160 are active, e.g., accounts that have student loans in a deferred, repayment, or grace period status. Credit data corresponding to the individuals with active accounts may be retrieved from the credit data database 206 by the engine 202. The credit data may be new or updated, as compared to credit data that may have been retrieved previously, such as by the system 100. The engine 202 may identify risk trends of the active accounts, based on the retrieved credit data. Risk trends may include increases in student loan defaults, increases in late repayments, increases in a student's debt-to-income ratio, growth in total loan balance, an increase, in total credit utilization, recent credit line decreases on revolving accounts, and/or a change in the amount of available credit, for example. One or more at-risk accounts of the active accounts may subsequently be identified by the engine 202 based on the identified risk trends and the retrieved credit data. The at-risk accounts may include active accounts that are in danger of going into default, such as when a student changes to a different sub-population in the compliance profile, e.g., a credit score drop, a move to another sub-population that is lower performing, an adverse change to particular credit-based attribute, etc.

The engine 202 can also review the student loan portfolio 160 at different points in time. For example, student loan decisions based on loan underwriting that uses risk criteria determined by the system 100 may be compared to loan decisions based on the previous loan underwriting that did not use the risk criteria. The results of the loan decisions (e.g., whether the 90/10 funding ratio requirement and other regulations are being satisfied, and whether revenue goals are being met) may be used to evaluate whether the risk criteria-based loan underwriting provided by the system 100 is in line with the expectations of the educational institution 150. Based on this evaluation, the risk criteria and student population segmentations may be calibrated by including new factors or removing particular factors that were initially used by the system 100 to create the risk criteria.

The student loan portfolio controller 158 and/or a collections review engine 204 in the system 200 may determine which accounts in the student loan portfolio 160 are past due, e.g., accounts that are in default status. Credit data corresponding to individuals with past due accounts may be retrieved from the credit data database 206 by the engine 204. The credit data may be new or updated, as compared to credit data that may have been retrieved previously, such as by the system 100. The engine 204 may determine a likelihood of repayment for the past due accounts, based on the retrieved credit data. The credit data corresponding to the past due accounts may indicate that repayment is now more likely. For example, the credit data may show that an individual has started a new job or has begun paying off other debts and loans. Updated contact information may also be present in the credit data, which can increase the chances of contacting an individual with a past due account. The updated contact information may also be helpful in obtaining information from former students, to assist the educational institution in complying with the cohort default rate and the gainful employment rule. If it is more likely that a defaulted student loan may be repaid, collections activities related to that past due account can be classified as a higher priority than other past due accounts.

FIG. 3 is a block diagram of a computing device 300 housing executable software used to facilitate the risk baseline determination and lead decision system 100 and the student loan portfolio assessment system 200. One or more instances of the computing device 300 may be utilized to implement any, some, or all of the components in the systems 100 and 200. Computing device 300 includes a memory element 304. Memory element 304 may include a computer readable medium for implementing the systems 100 and 200, and for implementing particular system transactions. Memory element 304 may also be utilized to implement the credit data databases 110 and 206. Computing device 300 also contains executable software, some of which may or may not be unique to the systems 100 and 200. Where a portion of the systems 100 and 200 is stored on the computing device 300, it is represented by, and is a component of, the credit risk decision facilitator 310. However, the credit risk decision facilitator 310 may also comprise other software to enable full functionality of the systems 100 and 200, such as, for instance, a standard Internet browsing interface application.

In some embodiments, the systems 100 and 200 and the credit risk decision facilitator 310 are implemented in software as an executable program, and is executed by one or more special or general purpose digital computer(s), such as a mainframe computer, a personal computer (desktop, laptop or otherwise), personal digital assistant, or other handheld computing device. Therefore, computing device 300 may be representative of any computer in which the systems 100 and 200 and the credit risk decision facilitator 310 resides or partially resides.

Generally, in terms of hardware architecture as shown in FIG. 3, computing device 300 includes a processor 302, a memory 304, and one or more input and/or output (I/O) devices 306 (or peripherals) that are communicatively coupled via a local interface 308. Local interface 308 may be one or more buses or other wired or wireless connections, as is known in the art. Local interface 308 may have additional elements, which are omitted for simplicity, such as controllers, buffers (caches), drivers, transmitters, and receivers to facilitate external communications with other like or dissimilar computing devices. Further, local interface 308 may include address, control, and/or data connections to enable internal communications among the other computer components.

Processor 302 is a hardware device for executing software, particularly software stored in memory 304. Processor 302 can be any custom made or commercially available processor, such as, for example, a Core series or vPro processor made by Intel Corporation, or a Phenom, Athlon or Sempron processor made by Advanced Micro Devices, Inc. In the case where computing device 300 is a server, the processor may be, for example, a Xeon or Itanium processor from Intel, or an Opteron-series processor from Advanced Micro Devices, Inc. Processor 302 may also represent multiple parallel or distributed processors working in unison.

Memory 304 can include any one or a combination of volatile memory elements (e.g., random access memory (RAM, such as DRAM, SRAM, SDRAM, etc.)) and nonvolatile memory elements (e.g., ROM, hard drive, flash drive, CDROM, etc.). It may incorporate electronic, magnetic, optical, and/or other types of storage media. Memory 304 can have a distributed architecture where various components are situated remote from one another, but are still accessed by processor 302. These other components may reside on devices located elsewhere on a network or in a cloud arrangement.

The software in memory 304 may include one or more separate programs. The separate programs comprise ordered listings of executable instructions for implementing logical functions. In the example of FIG. 3, the software in memory 304 may include the systems 100 and 200 and the credit risk decision facilitator 310, in accordance with the invention, and a suitable operating system (O/S) 312. Examples of suitable commercially available operating systems 312 are Windows operating systems available from Microsoft Corporation, Mac OS X available from Apple Computer, Inc., a Unix operating system from AT&T, or a Unix-derivative such as BSD or Linux. The operating system O/S 312 will depend on the type of computing device 300. For example, if the computing device 300 is a PDA or handheld computer, the operating system 312 may be iOS for operating certain devices from Apple Computer, Inc., PalmOS for devices from Palm Computing, Inc., Windows Phone 8 from Microsoft Corporation, Android from Google, Inc., or Symbian from Nokia Corporation. Operating system 312 essentially controls the execution of other computer programs, such as the systems 100 and 200 and the credit risk decision facilitator 310, and provides scheduling, input-output control, file and data management, memory management, and communication control and related services.

If computing device 300 is an IBM PC compatible computer or the like, the software in memory 304 may further include a basic input output system (BIOS). The BIOS is a set of essential software routines that initialize and test hardware at startup, start operating system 312, and support the transfer of data among the hardware devices. The BIOS is stored in ROM so that the BIOS can be executed when computing device 300 is activated.

Steps and/or elements, and/or portions thereof of the invention may be implemented using a source program, executable program (object code), script, or any other entity comprising a set of instructions to be performed. Furthermore, the software embodying the invention can be written as (a) an object oriented programming language, which has classes of data and methods, or (b) a procedural programming language, which has routines, subroutines, and/or functions, for example but not limited to, C, C++, C#, Pascal, Basic, Fortran, Cobol, Perl, Java, Ada, and Lua. Components of the systems 100 and 200 and the credit risk system facilitator 310 may also be written in a proprietary language developed to interact with these known languages.

I/O device 306 may include input devices such as a keyboard, a mouse, a scanner, a microphone, a touch screen, a bar code reader, or an infra-red reader. It may also include output devices such as a printer, a video display, an audio speaker or headphone port or a projector. I/O device 306 may also comprise devices that communicate with inputs or outputs, such as a short-range transceiver (RFID, Bluetooth, etc.), a telephonic interface, a cellular communication port, a router, or other types of network communication equipment. I/O device 306 may be internal to computing device 300, or may be external and connected wirelessly or via connection cable, such as through a universal serial bus port.

When computing device 300 is in operation, processor 302 is configured to execute software stored within memory 304, to communicate data to and from memory 304, and to generally control operations of computing device 300 pursuant to the software. The systems 100 and 200, the credit risk decision facilitator 310, and operating system 312, in whole or in part, may be read by processor 302, buffered within processor 302, and then executed.

In the context of this document, a “computer-readable medium” may be any means that can store, communicate, propagate, or transport data objects for use by or in connection with the systems 100 and 200 and the credit risk decision facilitator 310. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. The systems 100 and 200 and the credit risk decision facilitator 310 can be embodied in any type of computer-readable medium for use by or in connection with an instruction execution system or apparatus, such as a computer.

For purposes of connecting to other computing devices, computing device 300 is equipped with network communication equipment and circuitry. In a preferred embodiment, the network communication equipment includes a network card such as an Ethernet card, or a wireless connection card. In a preferred network environment, each of the plurality of computing devices 300 on the network is configured to use the Internet protocol suite (TCP/IP) to communicate with one another. It will be understood, however, that a variety of network protocols could also be employed, such as IEEE 802.11 Wi-Fi, address resolution protocol ARP, spanning-tree protocol STP, or fiber-distributed data interface FDDI. It will also be understood that while a preferred embodiment of the invention is for each computing device 300 to have a broadband or wireless connection to the Internet (such as DSL, Cable, Wireless, T-1, T-3, OC3 or satellite, etc.), the principles of the invention are also practicable with a dialup connection through a standard modem or other connection means. Wireless network connections are also contemplated, such as wireless Ethernet, satellite, infrared, radio frequency, Bluetooth, near field communication, and cellular networks.

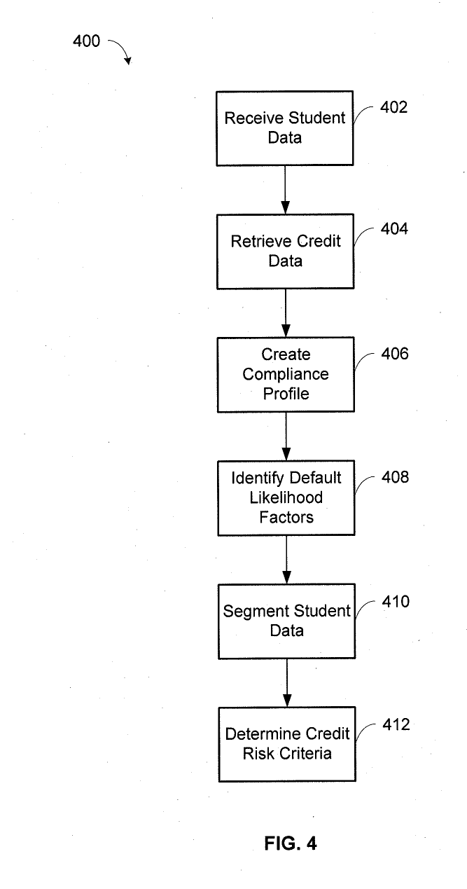

An embodiment of a process 400 for determining a risk baseline of an educational institution 150 is shown in FIG. 4. The process 400 can result in the determination of the risk baseline based on student data and credit data. The risk baseline may include risk criteria, such as credit score cut-offs and knock-out rules, which are based on an analysis of the student data and credit data. Components of the risk baseline determination and lead decision system 100 may perform all or part of the process 400. The process 400 may assist the educational institution 150 in determining credit behaviors that can forecast an individual's risk of defaulting on a student loan and therefore the educational institution's compliance with governmental regulations, such as the 90/10 funding ratio requirement, the cohort default rate, and the gainful employment rule, as described above.

At step 402, student data may be received at the compliance profile builder and analysis engine 102 from a student data source 152 at the educational institution 150. The student data may include current and/or historical information for one or more enrolled and/or former students of the educational institution 150. Student data for a statistically valid sample of enrolled and/or former students may be sufficient to produce the compliance profile. A statistically valid sample may include information for some or all of the enrolled and/or former students. The information in the student data may include names, addresses, identification numbers, educational history, payment history, and other data, as detailed above. Credit data may be retrieved from a credit data database 110 by the engine 102 at step 404, and may correspond to each of the enrolled and/or former students present in the student data received at step 402. The credit data may include credit history and other information, as described above.

At step 406, a compliance profile for the educational institution may be created as the result of a retrospective analysis performed by the engine 102 on the student data and the credit data. The compliance profile may correlate the credit-related behaviors of the students with loan default risk. The retrospective analysis may weight, compare, and contrast particular factors and parameters of the student data and the credit data in order to produce the compliance profile. The compliance profile may include characteristics of enrolled and/or former students who have defaulted on student loans or been delinquent in repayment. The compliance profile may include a series of decisioning rules and performance expectations that are based on credit score bands and/or segmentation of the compliance profile that are related to certain outcomes.

Default likelihood factors may be derived and identified at step 408 by the default likelihood factor identification engine 104. The default likelihood factors may include credit-based scores and attributes in an individual's credit data and credit history that best predict the likelihood that an individual may default on a student loan. The scores and attributes may be customized to match the desired risk and student acquisition outcomes as identified by the educational institution, as described above. The enrolled and former students in the student data may be segmented into sub-populations at step 410 by the segmentation and risk criteria determination engine 106. The segmentation may be based on the default likelihood factors identified at step 408. By segmenting the student data, sub-populations of the student data that have a higher risk of student loan defaults, and therefore would likely responsible for a larger percentage of losses due to loan defaults, may be identified at step 410. A risk baseline that includes risk criteria, such as credit score cut-offs and knock-out rules, may be determined by the engine 106 at step 412, based on the segmentation of the student data at step 410. The risk criteria may be utilized by the systems and processes of the invention to assist in the underwriting of student loans and in the compliance with financial aid regulations.

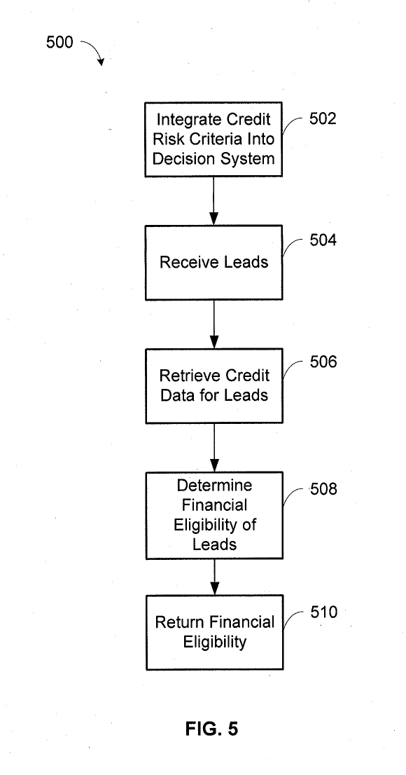

An embodiment of a process 500 for determining the repayment ability risk of prospective student leads with respect to student loan underwriting is shown in FIG. 5. The process 500 can return the repayment ability risk of prospective student leads, based on the risk criteria determined by the process 400, described above, and credit data corresponding to the prospective student leads. Components of the risk baseline determination and lead decision system 100 may perform all or part of the process 500. The process 500 may assist the educational institution 150 in screening and pre-screening of prospective students and in making financial aid and admissions decisions. Furthermore, the process 500 can assist the educational institution 150 in complying with governmental regulations, such as the 90/10 funding ratio requirement, the cohort default rate, and the gainful employment rule, as described above, by determining which of the prospective student leads may be less likely to default on student loans.

At step 502, the risk criteria determined by the process 400 may be integrated into a decision system, such as the lead decision engine 108 in the system 100. The engine 108 may utilize the risk criteria as a significant factor when making decisions regarding the repayment ability risk of prospective student leads. Prospective student leads may be received by the engine 108 at step 504. The prospective student leads may originate from a prospective student leads sources 154 at the educational institution 150, for example. A lead decision controller 156 at the educational institution may transmit the prospective student leads to the engine 108. Information about the prospective students in the prospective student leads source 154 may be provided by a third party and/or from existing students. The information about the prospective student leads may include names, addresses, identification numbers, etc., as described previously.

Credit data corresponding to each of the prospective student leads may be retrieved by the engine 108 at step 506 from a credit data database 110. Based on the information in the prospective student leads received at step 504 and the credit data for those prospective student leads retrieved at step 506, the engine 108 may determine the repayment ability risk of the prospective student leads at step 508. The credit scores and attributes in the credit data of the prospective student leads may be measured against the risk criteria to determine the repayment ability risk of the prospective student leads, e.g., whether the prospective student leads meet none, some, or all of the risk criteria. The repayment ability risk determined at step 508 may include a score, a grade, a debt load characterization, and/or another metric, such as a pass (meeting the risk criteria), no pass (not meeting the risk criteria), or a tag for different payment terms (meeting some of the risk criteria). The repayment ability risk may be returned to the educational institution 150 at step 510, such as to the lead decision controller 156. The educational institution 150 can use the determined repayment ability risk as a factor in its financial aid decisions, admissions decisions, and marketing efforts.

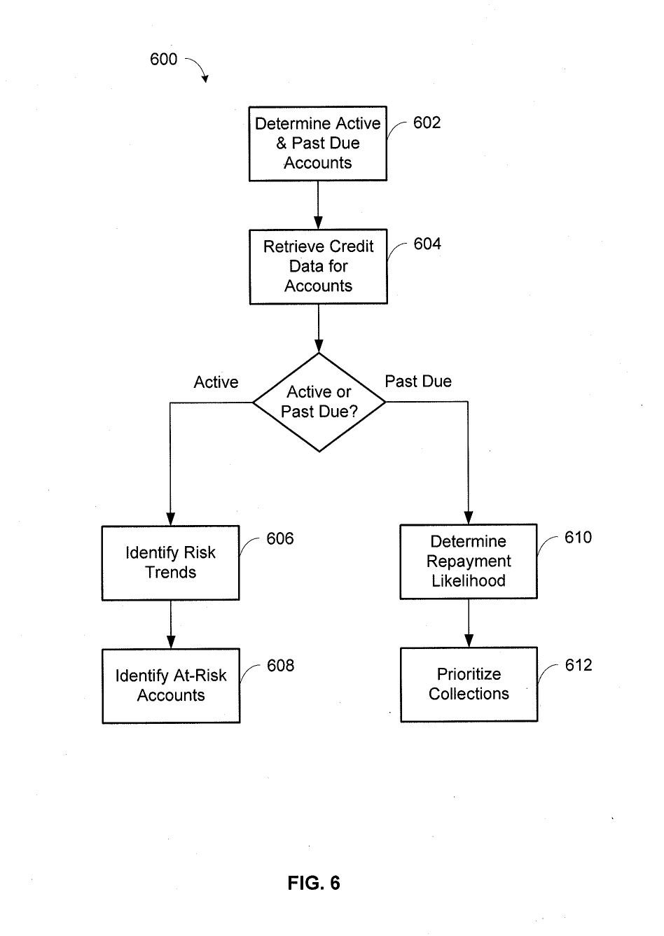

An embodiment of a process 600 for assessing a student loan portfolio 160 based on credit data is shown in FIG. 6. The process 600 can result in the identification of active at-risk accounts and the prioritization of collections for past due accounts. Components of the student loan portfolio assessment system 200 may perform all or part of the process 600. At step 602, active and past due accounts in a student loan portfolio may be determined. The student loan portfolio may be received by a portfolio review engine 202 from a student loan portfolio controller 158 at the educational institution 150. Data in the student loan portfolio 160 may include account information for existing federal and institutional student loans extended to enrolled and former students of the educational institution 150. Active accounts are accounts in the student loan portfolio 160 that have loans in a deferred, repayment, or grace period status. Past due accounts are accounts in the student loan portfolio 160 that have loans in default status. The engine 202, a collections review engine 204, and/or the controller 158 may determine which accounts in the student loan portfolio 160 are active and past due. Credit data corresponding to the individuals with the active and past due accounts may be retrieved by the engine 202 at step 604 from the credit data database 206. The credit data may be new or updated, as compared to credit data that may have been retrieved previously, such as by the processes 400 and 500.

At step 605, it may be determined whether an account retrieved at step 602 is active or past due. If the account is determined to be active at step 605, then the process 600 continues to step 606. Risk trends for the active accounts may be identified at step 606 by the engine 202, based on the credit data retrieved at step 604. Risk trends of the individuals with the active accounts may include increases in student loan defaults, increases in late repayments, or increases in a student's debt-to-income ratio, for example. Active at-risk accounts may be identified at step 608 by the engine 202 based on the risk trends identified at step 606 and the credit data retrieved at step 604. At-risk accounts may include the active accounts that are in danger of going into default with respect to the student loans associated with the account.

If the account is determined to be past due at step 605, then the process continues to step 610. At step 610, the engine 204 may determine a likelihood of repayment for the past due accounts, based on the credit data retrieved at step 604. The credit data corresponding to the past due accounts may indicate that repayment is now more likely, such as if the individual with the past due account has started a new job or begun paying off other debts and loans. Updated contact information may also be present in the credit data, which can increase the chances of contacting the individual with a past due account. Collections efforts for the past due accounts can be prioritized by the engine 204 at step 612, based on the determined likelihood of repayment. For example, if it is more likely that the individual may repay the defaulted student loan, collections activities related to those past due account can be classified as a higher priority that other past due accounts.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

It should be emphasized that the above-described embodiments of the invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the invention and protected by the following claims.

1. A method for establishing a risk baseline of an educational institution, the risk baseline comprising risk criteria, the method comprising:
receiving student data corresponding to a plurality of students of the educational institution;
retrieving credit data corresponding to each of the plurality of students;
analyzing the student data and the credit data to create a compliance profile, the compliance profile comprising a correlation of credit behaviors of the plurality of students with loan default risk;
identifying one or more loan default likelihood factors, based on the compliance profile;
segmenting the plurality of students into one or more sub-populations, based on the one or more loan default likelihood factors, the student data, and the credit data; and
determining risk criteria based on the sub-populations, the risk criteria comprising one or more of credit score cut-offs and knock-out rules.

2. The method of claim 1, wherein the student data comprises one or more of a name, an identification number, an address, a date of birth, a field of study, payment history, financial aid package information, an enrollment date, a graduation date, a risk score, or a risk profile.

3. The method of claim 1, wherein the credit data comprises one or more of a credit history, a payment delinquency, and a charge-off history.

4. The method of claim 1, wherein receiving student data comprises receiving student data from a student data source of the educational institution.

5. The method of claim 1, wherein analyzing comprises retrospectively analyzing the student data and the credit data to create the compliance profile.

6. The method of claim 1, further comprising customizing the one or more loan default likelihood factors to match desired risk and student acquisition outcomes of the educational institution.

7. The method of claim 1, wherein the plurality of students comprises a statistically valid representative sample of the plurality of students.

8. The method of claim 1, wherein the compliance profile further comprises a credit characteristic of the plurality of students associated with a particular outcome.

9. A method for determining a repayment ability risk of a prospective student lead to an educational institution based on a risk baseline comprising risk criteria, the method comprising:
receiving the prospective student lead from a lead decision controller;
retrieving credit data corresponding to the prospective student lead;
determining the repayment ability risk of the prospective student lead by measuring the credit data against the risk criteria, the repayment ability risk comprising one or more of a score, a grade, or a debt load characterization; and
transmitting the determined repayment ability risk to the lead decision controller.

10. The method of claim 9, further comprising:
retrieving updated credit data corresponding to the prospective student lead and credit data corresponding to one or more of a currently enrolled student; and
updating the risk criteria based on the updated credit data.

11. The method of claim 9, wherein:
the repayment ability risk comprises a pass decision, a no pass decision, and a tag for different payment terms;
the pass decision comprises if the credit data of the prospective student lead meets all of the risk criteria;
the no pass decision comprises if the credit data of the prospective student lead meets none of the risk criteria; and
the tag for different payment terms comprises if the credit data of the prospective student lead meets some of the risk criteria.

12. The method of claim 9, wherein the prospective student lead comprises one or more of a name, an identification number, and an address.

13. The method of claim 9, wherein the credit data comprises one or more of a credit history, a payment delinquency, a charge-off history, an income estimate, a debt-to-income estimate, a credit score, a derived credit score, or a credit scoring model.

14. A method for assessing a student loan portfolio comprising a plurality of student loan accounts, the method comprising:
determining one or more active student loan accounts in the student loan portfolio;
retrieving updated credit data corresponding to the one or more active student loan accounts;
identifying risk trends of the one or more active student loan accounts based on the updated credit data corresponding to the one or more active student loan accounts; and
identifying one or more at-risk accounts of the one or more active student loan accounts based on the risk trends and the updated credit data.

15. The method of claim 14, further comprising:
determining one or more past due student loan accounts in the student loan portfolio;
retrieving updated credit data corresponding to the one or more past due student loan accounts;
determining a likelihood of repayment for the past due accounts, based on the updated credit data corresponding to the one or more past due student loan accounts; and
prioritizing collections activities related to the past due accounts based on the likelihood of repayment.
